(19) United States
(12) Patent Application Publication
(10) Pub. No.: US 2021/0047866 A1
(43) Pub. Date: Feb. 18, 2021

(54) LOCKING MECHANISMS

(71) Applicant: Hewlett-Packard Development Company, L.P., Spring, TX (US)

(72) Inventor: Hsin-Ming Chen, Taipei (TW)

(73) Assignee: Hewlett-Packard Development Company, L.P., Spring, TX (US)

(21) Appl. No.: 16/976,582

(22) PCT Filed: Apr. 19, 2018
(86) PCT No.: PCT/US2018/028297

§ 371 Date: Aug. 28, 2020

(51) Int. Cl. E05B 73/00; G06F 21/31; G06F 21/86; G06F 21/88; E05B 47/00

(52) U.S. Cl. CPC E05B 73/0082; G06F 21/31; E05B 47/0012; G06F 21/86; G06F 21/88; E05B 73/0005

(57) ABSTRACT

Locking mechanisms are described herein. In one example, a locking mechanism can include an aperture to receive a lock head when the lock head is in a first position, a latch head to prevent the lock head from moving through the aperture when the lock head is in a second position, and/or an actuator coupled to the latch head to move the lock head from the second position to the first position in response to an authentication.

### BACKGROUND

Mobile computing devices can include apertures to accept cable locks. The cable locks can include keyed locks that can rotate a locking head within the aperture to lock the mobile computing device to a work station or object near the work station. The cable locks can utilize a key to be able to turn the locking head within the aperture. The cable locks can be utilized to lock the mobile computing device to a work station or object to prevent theft of the mobile computing device.

### BRIEF DESCRIPTION OF THE DRAWINGS

FIG. 1 illustrates an example device for a locking mechanism consistent with the present disclosure.

FIG. 2 illustrates an example device for a locking mechanism consistent with the present disclosure.

FIG. 3 illustrates an example device for a locking mechanism consistent with the present disclosure.

FIG. 4 illustrates an example method for locking a locking mechanism consistent with the present disclosure.

FIG. 5 illustrates an example method for unlocking a locking mechanism consistent with the present disclosure.

### DETAILED DESCRIPTION

Mobile computing device such as laptop computers can be transported between a plurality of different locations. In some examples, the mobile computing devices can be utilized at a work station such as a desk or cubicle. When a user leaves the work station without the mobile computing device, the mobile computing device can be susceptible to theft. The locking mechanism described herein can be utilized to secure the mobile computing device to a desk or other object that can make it more difficult for a steal the mobile computing device.

Mobile computing devices can include apertures to receive other types of locking mechanisms such as key locks and combination locks that can utilize a combination lock and/or a key to lock and unlock the locking mechanism. Key locks and combination locks can be problematic if the key or combination is lost or stolen. The locking mechanisms described herein can be keyless and can utilize a plurality of different authentication techniques. For example, the locking mechanisms described herein can utilize the mobile computing device to authenticate a user attempting to unlock the locking mechanisms described herein. In this example, the mobile computing device can provide an actuator with electrical power when the authentication is provided to the computing device. In this way, a more secure authentication can be utilized to unlock the computing device.

Locking mechanisms are described herein. In one example, a locking mechanism can include an aperture to receive a lock head when the lock head is in a first position, a latch head to prevent the lock head from moving through the aperture when the lock head is in a second position, and/or an actuator coupled to the latch head to move the lock head from the second position to the first position in response to an authentication. In some examples, the locking mechanisms described herein can utilize an actuator positioned within the enclosure of the computing device to lock a lock head of a cable lock with a rotation of the lock head and unlock the lock head of the cable lock with an authentication provided to the computing device. In this way, a plurality of different authentication techniques can be utilized unlock the lock head of the cable lock.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

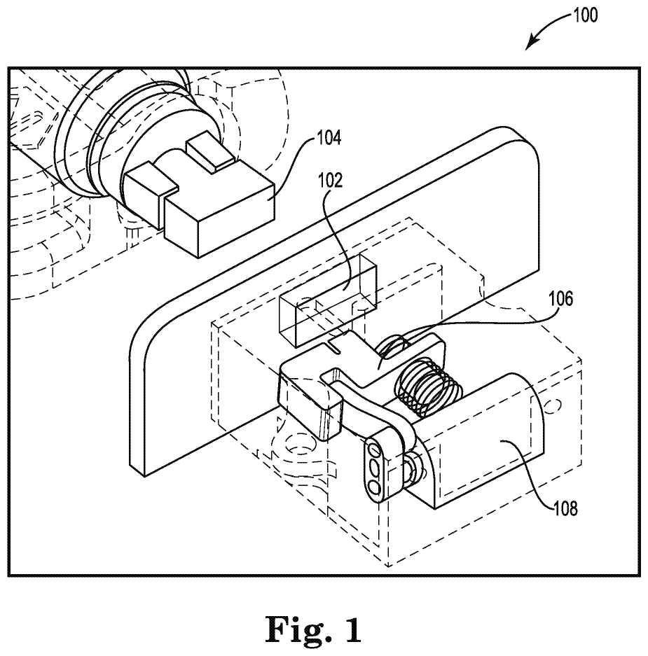

FIG. 1 illustrates an example device for a locking mechanism 100 consistent with the present disclosure. FIG. 1 can illustrate a locking mechanism 100 that can be utilized with a computing device. For example, the locking mechanism 100 can utilize an aperture 102. The aperture 102 can be positioned within an enclosure of the computing device. In some examples, the locking mechanism 100 can utilize locking element with a lock head 104. For example, the locking mechanism 100 can utilize a cable lock with a lock head 104 coupled to a cable that can be coupled to a work station when the lock head 104 is coupled within the aperture 102.

In some examples, the lock head 104 can have a shape that corresponds to the shape of the aperture 102. For example, the lock head 104 can have a rectangular shape that can correspond to a rectangular shape of the aperture 102. In some examples, the lock head 104 can be rotatable between a plurality of positions. For example, the lock head 104 can be rotatable such that the lock head 104 can be positioned within the aperture 102. In this example, the lock head 104 can be rotated such that the lock head 104 may not be positioned within the aperture 102. As illustrated in FIG. 1, the lock head 104 can be rotated into a position that corresponds to the position of the aperture 102.

In some examples, the locking mechanism 100 can include a latch head 106. The latch head 106 can include a first portion and a second portion. In some examples, the first portion of the latch head 106 can be coupled to an actuator and the second portion of the latch head 106 can include an L-shaped portion to receive the lock head 104 when the lock head 104 is rotated within the aperture 102. In some examples, the actuator 108 can be an electrical actuator that can be activated using electrical power (e.g., electricity, etc.). For example, the actuator 108 can be coupled to a controller of the computing device. In this example, the actuator 108 can be provide electrical power when an authentication of a user has been provided to the computing device.

In some examples, the actuator 108 can be coupled to the latch head 106 to move the latch head 106 from a first location to a second location. In some examples, the first location can be a locked location and the second location can be an unlocked location. In some examples, the first location of the latch head 106 is a position of the latch head 106 near or at the aperture 102. For example, the latch head 106 can be positioned close to the enclosure and/or the aperture 102 of the enclosure. In some examples, the first portion of the latch head 106 can abut or be in contact with the enclosure and the second portion of the latch head 106 can be positioned directly behind the aperture 102. In some examples, the second portion of the latch head 106 can cover a portion of the aperture 102 when the latch head 106 is in the first location.

In some examples, the locking mechanism 100 can include a resistive element, As used herein, a resistive element can include a spring loaded mechanism such as a spring to apply a force on a device. In some examples, the resistive element can be coupled to the latch head 106. In some examples, the resistive element can be coupled to the second portion of the latch head 106, In some examples, the resistive element can be utilized to apply a force on the latch head 106 to maintain the latch head 106 in the first location. For example, the resistive element can be utilized to apply a force on the latch head toward the aperture 102.

In some examples, the locking mechanism 100 can be utilized to lock a computing device to a cable that can be attached to a work station. In some examples, the locking mechanism 100 can be utilized with a locking method and an unlocking method. In some examples, a locking method can include inserting the lock head 104 into the aperture, Inserting the lock head 104 into the aperture 102 can move the latch head 106 away from the aperture 102 and toward the actuator 108. For example, inserting the lock head 104 into the aperture 102 can move the latch head 106 from a first location to a second location.

In some examples, the lock head 104 can contact a portion of the latch head 106 when the lock head 104 is inserted into the aperture. In one example, the lock head 104 can move the latch head 106 to a second location. In this example, the lock head 104 can be rotated to a second position when the latch head 106 is in the second location and/or when the lock head 104 is positioned within the aperture 102. When the lock head 104 is rotated to a second position, the lock head 104 may no longer interact with the latch head 106 and the resistive element can move the latch head 106 from the second location to the first location. When the latch head 106 is in the first location, a portion of the latch head 106 can interact with the lock head 104 and prevent the lock head 104 from being rotated to the first position. In these examples, the lock head 104 may not be able to be removed through the aperture 102 when the lock head 104 is in the second position.

As described herein, the locking mechanism 100 can include an unlocking method to remove the lock head 104 from the aperture 102. The unlocking method can include providing an authentication to the computing device. As used herein, an authentication can include proving that a user is authorized to unlock the locking mechanism 100. In some examples, an authentication technique can be utilized to prove that a user is authorized to unlock the locking mechanism 100. For example, an authentication technique can include, but is not limited to: a user name and password combination, an iris scan, a fingerprint scan, an audio scan, a facial scan, and/or other type of authentication technique that can be provided by the computing device.

In some examples, an authentication can be provided to the computing device as described herein. In some examples, the computing device can determine, based on the authentication technique, that a user is authorized to remove the lock head 104 through the aperture 102. In some examples, the computing device can provide electrical power to the actuator 108 in response to determining the authentication of the user. For example, the computing device can provide electrical power to the actuator 108 when the computing device receives an accepted user name and password combination.

As used herein, an actuator 108 can include a device that can provide mechanical power to move a device. For example, the actuator 108 can include a drive shaft that can be moved when electrical power is provided to the actuator 108. In some examples, the actuator 108 can receive the electrical power from the computing device and move the latch head 106 from the first position to the second position. In some examples, the actuator 108 can receive electrical power from the computing device and move the latch head 106 away from the aperture 102 to release the lock head 104 from interacting with the latch head 106. When the actuator 108 moves the latch head 106 to the second location the lock head 104 can be rotated and removed through the aperture 102 to unlock the computing device.

The locking mechanism 100 can be utilized with an authentication technique of the computing device to unlock the computing device from the lock head 104. By utilizing authentication techniques through the computing device, additional keys or combinations can be removed from the locking mechanism 100. In addition, the authentication techniques of the computing device can be more secure than a key or combination lock.

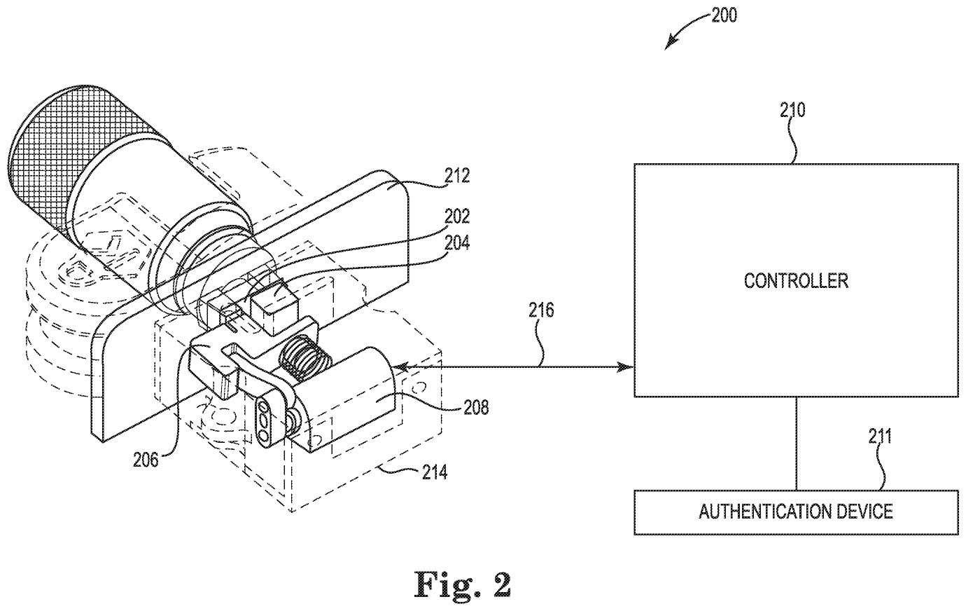

FIG. 2 illustrates an example device for a locking mechanism 200 consistent with the present disclosure. In some examples, the locking mechanism 200 can include the same or similar elements as the locking mechanism 100 as referenced in FIG. 1. For example, the locking mechanism 200 can include a lock head 204 that can be inserted into an aperture 202 to lock a computing device as described herein.

In some examples, the locking mechanism 200 can include an enclosure 212 with an aperture 202 positioned within the enclosure 212. In some examples, the enclosure 212 can be an enclosure of a computing device. For example, the enclosure of a computing device can be a protective material to enclose the components of the computing device. As described herein, the aperture 202 can be the same or similar shape as a lock head 204 such that the lock head 204 can be inserted into the aperture 202. In some examples, the lock head 204 can be inserted into the aperture 202 when the lock head is in a first position (e.g., a position that aligns the lock head 204 in the same direction as the aperture 202, etc.).

The locking mechanism 200 can include an enclosure 214 to enclose a number of components of the locking mechanism 200. For example, the enclosure 214 can enclose a latch head 206, a resistive element, a link or shaft coupled to an actuator 208, and/or the actuator 208. In some examples, the enclosure 214 can be positioned within the enclosure 212. For example, the enclosure 214 can be positioned within the enclosure 212 to receive the lock head 204 within the enclosure 212 when the lock head 204 is inserted through the aperture 202.

As described herein, the lock head 204 can be inserted into the aperture 202 and interact with the latch head 206. For example, the lock head 204 can be inserted into the aperture 202 and make physical contact with the latch head 206. In this example, the contact of the lock head 204 can move the latch head 206 from a first location near the aperture 202 toward the actuator 208 to a second location. In some examples, the lock head 204 can be rotated when the latch head 206 has been moved to the second position near the actuator 208. In these examples, rotating the lock head 204 from a first position to a second position within the enclosure 214 can prevent the lock head 204 from being removed through the aperture 202 since the lock head 204 would interact with the enclosure 214 surrounding the aperture 202.

In some examples, the lock head 204 can be rotated when the lock head 204 has moved the latch head 206 from a first location near the aperture 202 to a second location near the actuator 208. When the lock head is rotated from a first position to a second position, the latch head 206 can move from the second location to the first location and a portion of the latch head 206 can interact with lock head 204 to prevent the lock head 204 from being rotated back to the first position and removed through the aperture 202.

FIG. 2 illustrates when the locking mechanism 200 is in a locked position. For example, the lock head 204 can be rotated from a first position that allows the lock head 204 to be inserted through the aperture 202 to a second position that prevents the lock head 204 from being removed through the aperture 202. When the lock head 204 is rotated to the second position, a portion of the latch head 206 can interact with the lock head 204 to prevent rotation of the lock head 204. In some examples, the portion of the latch head 206 that interacts with the lock head 204 can correspond to a shape of the lock head 204. For example, the portion of the latch head 206 that interacts with the lock head 204 can have a shape that corresponds to the shape of the lock head 204 such that the lock head 204 can be positioned within the portion of the latch head 206.

In some examples, the portion of the latch head 206 can interact with at least two sides of the lock head 204 to prevent rotational movement of the lock head 204 when the locking mechanism is in the locked position as illustrated in FIG. 2. In some examples, the portion of the latch head 206 can be an L-shaped portion that can receive the lock head 204 when the lock head 204 has a rectangular shape. In this example, the two sides of the L-shaped portion of the latch head 206 can interact with two corresponding sides of the lock head 204 to prevent rotational movement of the lock head 206 when the locking mechanism 200 is in the locked position as illustrated in FIG. 2.

In some examples, the locking mechanism 200 can include a controller 210. In some examples, the controller 210 can be a processing resource of a computing device. For example, the controller 210 can be a processing resource coupled to a memory resource within the enclosure 212 of a mobile computing device. In some examples, the controller 210 can be coupled to the actuator 208. In some examples, the controller 210 can be electrically coupled to the actuator by an electrical connection 216. In some examples, the controller 210 can be coupled to an authentication device that can utilize a plurality of different authentication techniques. As used herein, a controller 210 can include a processing resource that can execute instructions stored on a memory resource. In some examples, the controller 210 can be an input/output (I/O) controller that can be coupled to a processing resource of the computing device such as a central processing unit (CPU) of the computing device.

In some examples, the controller 210 can receive an instruction from the computing device to unlock the locking mechanisms 200. For example, the computing device can receive an authentication through an authentication technique provided to the computing device. As used herein, an authentication technique includes a method of proving an identify of a user. For example, authentication techniques can include, but are not limited by: a facial recognition technique, a user name and password combination, an iris scan technique, a fingerprint scan technique, and/or a voice recognition technique. In some examples, the authentication technique can be received by an authentication device 211. As used herein, an authentication device 211 can include a device to receive an input from a user and/or a device to authenticate the user based on the received input. For example, the authentication device 211 can include a camera to receive an image of the user and instructions to compare the received image to a stored image. In this example, the user can be authenticated when the authentication device 211 determines that the identity of the user.

In some examples, the controller 210 can receive a signal from the authentication device 211 to instruct the controller 210 to unlock the locking mechanism 200. In some examples, the controller 210 can send electrical power to the actuator 208 through the electrical connection 216 to activate the actuator 208. As described herein, the actuator 208 can be an electrically motorized actuator to move the latch head 206 from the first position as illustrated in FIG. 2 to a second position toward the actuator 208. In this way, the portion (e.g., L-shaped portion, second portion, etc.) of the latch head 206 that interacts with the lock head 202 can be moved away from the lock head 204 to allow the lock head 204 to be rotated to a position that can allow the lock head 204 to be removed through the aperture 202.

In some examples, the controller 210 can provide electrical power to the actuator 208 when the actuator 208 is a single direction motorized actuator. For example, the actuator 208 may only be able to move in a single direction. In this example, the actuator 208 can rotate a shaft in the single direction that is coupled to a link coupled to the latch head 206. In this example, the rotation of the shaft can move the link coupled to the latch head 206 from a first location as illustrated in FIG. 2 toward the actuator 208 to a second location as described herein. In this example, the controller 210 can restrict or remove electrical power from the actuator 208 to allow the latch head 206 to be moved back to the first location by a force provided by a resistive element (e.g., spring, etc.). In some examples, the actuator 208 can be coupled to a first portion of the latch head 206 and a resistive element can be coupled to a second portion of the latch head 206.

As described herein, the locking mechanism 200 can be a keyless locking mechanism that can utilize an authentication device 211 of the computing device to unlock the locking mechanism 200 and allow the lock head 204 to be rotated and removed through the aperture 202 as described herein. In some examples, the authentication device 211 can provide more secure authentication compared to a key or combination lock, since a key or combination can be lost or stolen. Thus, the locking mechanism 200 can be more secure than key or combination locks.

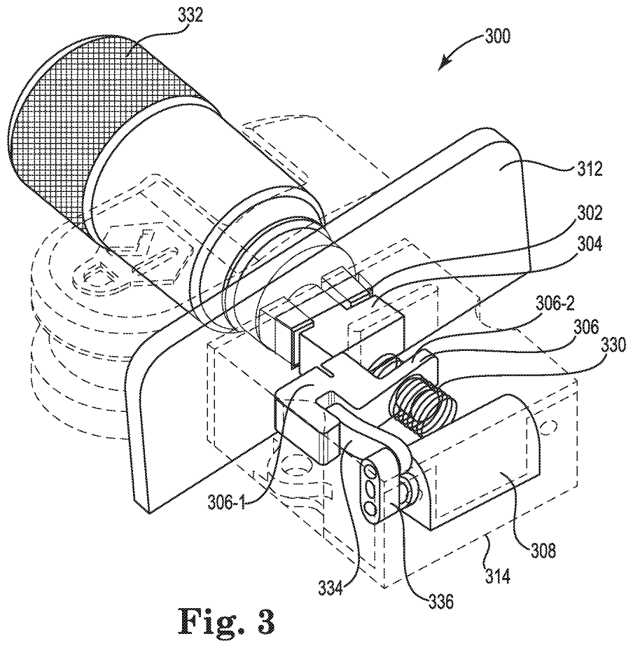

FIG. 3 illustrates an example device for a locking mechanism 300 consistent with the present disclosure. In some examples, the locking mechanism 300 can include the same or similar elements as the locking mechanism 100 as referenced in FIG. 1 and/or the locking mechanism 200 as referenced in FIG. 2. For example, the locking mechanism 300 can include a lock head 304 that can be inserted into an aperture 302 to lock a computing device as described herein.

In some examples, the locking mechanism 300 can include an enclosure 312 with an aperture 302 positioned within the enclosure 312. In some examples, the enclosure 312 can be an enclosure of a computing device. For example, the enclosure of a computing device can be a protective material to enclose the components of the computing device. As described herein, the aperture 302 can be the same or similar shape as a lock head 304 such that the lock head 304 can be inserted into the aperture 302.

The locking mechanism 300 can include an enclosure 314 to enclose a number of components of the locking mechanism 300. For example, the enclosure 314 can enclose a latch head 306, a resistive element 330, a link 334 and/or a shaft 336 coupled to an actuator 308, and/or the actuator 308. In some examples, the enclosure 314 can be positioned within the enclosure 312. For example, the enclosure 314 can be positioned within the enclosure 312 to receive the lock head 304 within the enclosure 312 when the lock head 304 is inserted through the aperture 302.

In some examples, the lock head 304 can be inserted into the aperture 302 when the lock head is in a first position (e.g., a position that aligns the lock head 304 in the same direction as the aperture 302, position that is illustrated in FIG. 3, etc.). In some examples, the lock head 304 can make physical contact with a latch head 306. As described herein, the latch head 306 can include a first portion 306-1 that is coupled to an actuator 308 through a link 334 and a shaft 336. In addition, the latch head 306 can include a second portion 306-2 that can be coupled to a resistive device 330. In some examples, the resistive device 330 can apply a force on the second portion 306-2 of the latch head 306 toward the direction of the aperture 302. In some examples, the resistive device 330 can be utilized to move the latch head 306 to a first location. In some examples, the actuator 308 can utilize the shaft 336 and/or the link 334 to apply a force on the first portion 306-1 of the latch head 306 in a direction toward the actuator 308 or away from the aperture 302 to a second location.

As described herein, the lock head 304 can be inserted into the aperture 302 and interact with the second portion 306-2 of the latch head 306. For example, the lock head 304 can be inserted into the aperture 302 and make physical contact with the latch head 306. In this example, the contact of the lock head 304 can move the latch head 306 from a first location near the aperture 302 toward the actuator 308 to a second location. In some examples, the lock head 304 can be rotated by a rotatable cable head 332 when the latch head 306 has been moved to the second position near the actuator 308. In these examples, rotating the lock head 204 utilizing the rotatable cable head 332 from a first position to a second position within the enclosure 314 can prevent the lock head 304 from being removed through the aperture 302 since the lock head 304 would interact with the enclosure 314 surrounding the aperture 302.

In some examples, the lock head 304 can be rotated utilizing the rotatable cable head 332 when the lock head 304 has moved the latch head 306 from a first location near the aperture 302 to a second location near the actuator 308. When the lock head is rotated from a first position to a second position, the latch head 306 can move from the second location to the first location and the second portion 306-2 of the latch head 306 can interact with lock head 304 to prevent the lock head 304 from being rotated back to the first position with the rotatable cable head 332 and removed through the aperture 302.

FIG. 3 illustrates when the locking mechanism 300 is in an unlocked position. For example, the lock head 304 can be rotated by the rotatable cable head 332 to a first position that allows the lock head 304 to be inserted through the aperture 302. When the lock head 304 is rotated by the rotatable cable head 332 to a second position within the enclosure 312, a second portion 306-2 of the latch head 306 can interact with a portion of the lock head 304 to prevent further rotation of the lock head 304 by the rotatable cable head 332. In some examples, the second portion 306-2 of the latch head 306 that interacts with the lock head 304 can correspond to a shape of the lock head 304. For example, the second portion 306-2 of the latch head 306 that interacts with the lock head 304 can have a shape that corresponds to the shape of the lock head 304 such that the lock head 304 can be positioned within the second portion 306-2 of the latch head 306 when the lock head 304 is rotated from the first position to the second position.

In some examples, the second portion 306-2 of the latch head 306 can interact with at least two sides of the lock head 304 to prevent rotational movement of the lock head 304 by the rotatable cable head 332 when the locking mechanism 300 is in the locked position as illustrated in FIG. 2. In some examples, the second portion 306-2 of the latch head 306 can be an L-shaped portion that can receive the lock head 304 when the lock head 304 has a rectangular shape. In this example, the two sides of the L-shaped portion of the latch head 306 can interact with two corresponding sides of the lock head 304 to prevent rotational movement of the lock head 306 with the rotatable cable head 332 when the locking mechanism 300 is in the locked position as illustrated in FIG. 2.

As illustrated in FIG. 3, the locking mechanism 300 is in an unlocked position. That is, the lock head 304 can be in a first position that can be inserted through the aperture 302 without interacting with the enclosure 312. In this way, the rotatable cable head 332 can rotate the lock head 304. As described herein, the lock head 304 can be rotated within the enclosure 314 to lock the locking mechanism 300.

In some examples, a controller (e.g., controller 210 as referenced in FIG. 2, etc.) can receive an instruction from the computing device to unlock the locking mechanisms 300. For example, the computing device can receive an authentication through an authentication technique provided to the computing device. As used herein, an authentication technique includes a method of proving an identity of a user. For example, authentication techniques can include, but are not limited by: a facial recognition technique, a user name and password combination, an iris scan technique, a fingerprint scan technique, and/or a voice recognition technique. In some examples, the authentication technique can be received by an authentication device. As used herein, an authentication device can include a device to receive an input from a user and/or a device to authenticate the user based on the received input. For example, the authentication device can include a camera to receive an image of the user and instructions to compare the received image to a stored image. In this example, the user can be authenticated when the authentication device determines that the identity of the user.

In some examples, the controller can receive a signal from the authentication device to instruct the controller to unlock the locking mechanism. In some examples, the controller can send electrical power to the actuator 308 through the electrical connection to activate the actuator 308. As described herein, the actuator 308 can be an electrically motorized actuator to move the latch head 306 from the first position as illustrated in FIG. 2 to a second position as illustrated in FIG. 3. In this way, the second portion 306-2 (e.g., L-shaped portion, etc.) of the latch head 306 that interacts with the lock head 302 can be moved away from the lock head 304 to allow the lock head 304 to be rotated by the rotatable cable head 332 to a position that can allow the lock head 304 to be removed from the enclosure 312 through the aperture 302.

In some examples, the controller can provide electrical power to the actuator 308 when the actuator 308 is a single direction motorized actuator. For example, the actuator 308 may only be able to move in a single direction. In this example, the actuator 308 can rotate a shaft 336 in the single direction that is coupled to a link 334 coupled to the latch head 306. In this example, the rotation of the shaft 336 can move the link 334 coupled to the latch head 306 from a first location as illustrated in FIG. 2 toward the actuator 208 to a second location as illustrated in FIG. 3. In this example, the controller can restrict or remove electrical power from the actuator 308 to allow the latch head 306 to be moved back to the first location by a force provided by a resistive element 330 (e.g., spring, etc.). In some examples, the actuator 308 can be coupled to a first portion 306-1 of the latch head 306 and a resistive element 330 can be coupled to a second portion 306-2 of the latch head 306.

As described herein, the locking mechanism 300 can be a keyless locking mechanism that can utilize an authentication device of the computing device to unlock the locking mechanism 300 and allow the lock head 304 to be rotated by the rotatable cable head 332 and removed through the aperture 302 as described herein. In some examples, the authentication device can provide more secure authentication compared to a key or combination lock, since a key or combination can be lost or stolen. Thus, the locking mechanism 300 can be more secure than key or combination locks.

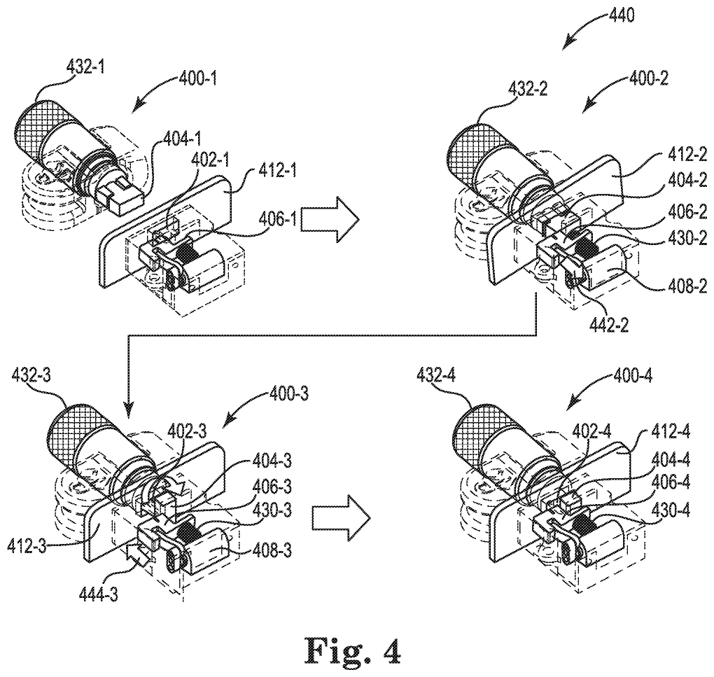

FIG. 4 illustrates an example method 440 for locking a locking mechanism consistent with the present disclosure. As described herein, the locking mechanisms 400-1, 400-2, 400-3, 400-4 can be keyless locks that can utilize an authentication device through the computing device. In some examples, the method 440 can be utilized to lock the computing device to a work station or object as described herein. The locking mechanisms 400-1, 400-2, 400-3, 400-4 can each represent a particular part of the method 440. In some examples, the locking mechanisms 400-1, 400-2, 400-3, 400-4 can be the same or similar locking mechanisms as locking mechanism 100 as illustrated in FIG. 1, locking mechanism 200 as illustrated in FIG. 2, and/or locking mechanism 300 as illustrated in FIG. 3.

The method 440 can begin as illustrated by locking mechanism 400-1. Locking mechanism 400-1 can include a lock head 404-1 that is located at an exterior position of the enclosure 412-1. In some examples, the lock head 404-1 can be rotated by a rotatable cable head 432-1 such that the lock head 404-1 is aligned with an aperture 402-1 of the enclosure 412-1. In some examples, the locking mechanism 400-1 can include a latch member 406-1 that is at a first location. As described herein, the latch member 406-1 can be at the first location when the latch member 406-1 is positioned near the aperture 402-1 of the enclosure 412-1. In some examples, the latch member 406-1 can block or cover a portion of the aperture 402-1 when the latch member 406-1 is in the first location. In some examples, the latch member 406-1 can prevent debris or other objects from entering the aperture 402-1.

The method 440 can continue as illustrated by locking mechanism 400-2. Locking mechanism 400-2 illustrates the lock head 404-2 that has been positioned within the aperture 402-2 of the enclosure 412-2. As described herein, the lock head 404-2 can be inserted into the aperture 402-2 and interact or physically contact the latch head 406-2. In some examples, the lock head 404-2 can move the latch head 406-2 in a direction illustrated by arrow 442-2. In some examples, the lock head 404-2 can move the latch head 406-2 to a second location that is closer to the actuator 408-2 than the first location. In some examples, the lock head 404-2 overcome a resistive force applied by a resistive element 430-2 to move the latch head 406-2 from the first location to the second location.

The method 440 can continue as illustrated by locking mechanism 400-3. As described herein, the lock head 404-3 can be rotated by a rotatable cable head 432-3. When the lock head 404-3 is inserted into the aperture 402-3 to move the latch head 406-3 to the second position as illustrated by locking mechanism 400-2, the lock head 404-3 can be rotated by the rotatable cable head 432-3. As described herein, the latch head 406-3 can include a portion that corresponds to the shape of the lock head 404-3 when the lock head 404-3 is rotated within the aperture 402-3. When the lock head 404-3 is rotated within the aperture 402-3, the latch member 406-3 can move in a direction as illustrated by arrow 444-3. As described herein, a resistive element 430-3 can be utilized to apply a force in the direction as illustrated by arrow 444-3 on the latch member 406-3 to move the latch member 406-3 in the direction of arrow 444-3 when the lock head 404-3 is rotated by the rotatable cable head 432-3

The method 440 can continue as illustrated by locking mechanism 400-4. In some examples, the locking mechanism 400-4 can illustrate when the locking mechanism is in a locked position. Locking mechanism 400-4 can illustrate that the resistive element 430-4 has moved the latch head 406-4 to the first location such that a portion of the latch head 406-4 interacts with a portion of the lock head 404-4 to prevent the lock head 404-4 from being rotated by the rotatable cable head 432-4. As described herein, the lock head 404-4 can be in a position that prevents the lock head 404-4 from being removed through the aperture 402-4. For example, the lock head 404-4 as illustrated by locking mechanism 400-4 can interact with the enclosure 412-4 when applying a force to remove the lock head 404-4 from the enclosure 412-4 through the aperture 402-4.

The method 440 can illustrate one example of locking a computing device to a keyless cable lock. As illustrated by method 440, the lock head 404-4 can be locked within the enclosure 412-4 without utilizing an actuator 408. For example, the resistive element 430-4 can move the latch head 406-4 to a location that prevents the lock head 404-4 from being rotated.

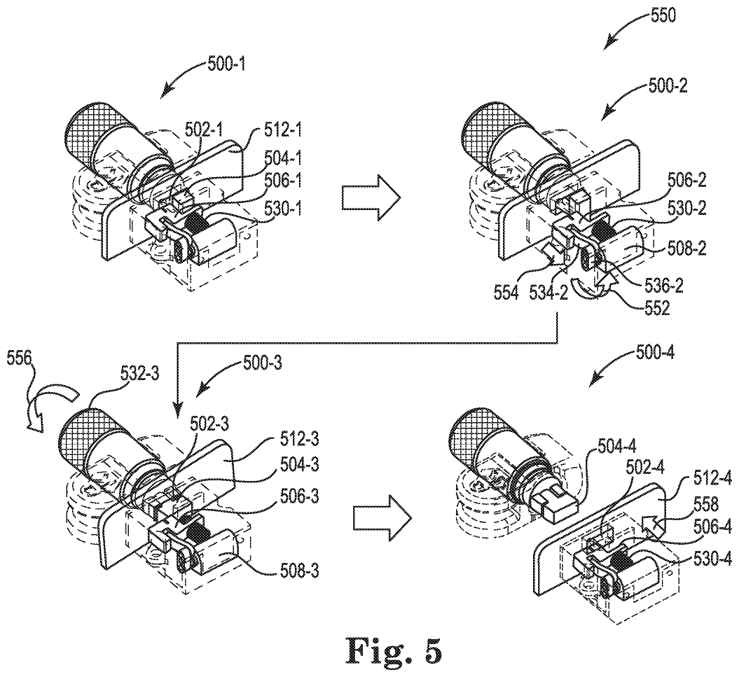

FIG. 5 illustrates an example method 550 for unlocking a locking mechanism consistent with the present disclosure. The method 550 can illustrate unlocking a locking mechanism as described herein. In some examples, the method 550 can utilize locking mechanisms 500-1, 500-2, 500-3, 500-4 to illustrate one example of how to unlock a locking mechanism. The locking mechanisms 500-1, 500-2, 500-3, 500-4 can each represent a particular part of the method 440. In some examples, the locking mechanisms 500-1, 500-2, 500-3, 500-4 can be the same or similar locking mechanisms as locking mechanism 100 as illustrated in FIG. 1, locking mechanism 200 as illustrated in FIG. 2, and/or locking mechanism 300 as illustrated in FIG. 3.

The method 550 can begin as illustrated by locking mechanism 500-1. The locking mechanism 500-1 can illustrate when the locking mechanism is in a locked position. That is, the lock head 502-1 can be in a position that does not allow the lock head 502-1 to be removed through the aperture 502-1 of the enclosure 512-1. In some examples, the latch head 506-1 can be in a first location as described herein with a force being applied to the latch head 506-1 with a resistive element 530-1. In this way, the latch head 506-1 can prevent the lock head 504-1 from being rotated to an unlocked position that is capable of being moved through the aperture 502-1.

The method 550 can continue as illustrated by locking mechanism 500-2. As described herein, a controller or other type of computing device can be utilized to validate an identity or validate that a user is authorized to unlock the locking mechanism 500-2. In some examples, when a user is authorized and provides a correct authentication to the controller, the controller can provide electrical power to an actuator 508-2. When electrical power is provide to the actuator 508-2, the actuator 508-2 can rotate a shaft 536-2 in a direction as illustrated by arrow 552. In some examples, the shaft 536-2 can be coupled to a link 534-2. When the shaft 536-2 rotates, the link 534-2 coupled to the latch head 506-2 can move the latch head 506-2 in a direction illustrated by arrow 554 toward the actuator 508-2. In some examples, the force applied by the actuator 508-2 can overcome the force applied by the resistive element 530-2 to move the latch head in the direction of arrow 554.

The method 550 can continue as illustrated by locking mechanism 500-3. Locking mechanism 500-3 can illustrate when the latch head 506-3 has moved to a second location near the actuator 508-3 such that the latch head 506-3 does not interact or contact the lock head 504-3. When the latch head 506-3 is located at the second location near the actuator 508-3, the lock head 504-3 can be rotated by a rotatable cable head 532-3 in the direction of arrow 556. In some examples, the lock head 504-3 can be rotated to align the shape of the lock head 504-3 with the shape of the aperture 502-4 within the enclosure 512-3.

The method 550 can continue as illustrated by locking mechanism 500-4. When the lock head 504-4 is aligned with the aperture 502-4, the lock head 504-4 can be removed through the aperture 502-4 without interacting with the enclosure 512-4. In some examples, removing the lock head 504-4 can allow the resistive element 530-4 to provide a force on the latch head 506-4 in the direction of arrow 558 to move the latch head 506-4 back to the first location and/or the original location to receive the lock head 504-4 as described in reference to method 440 as illustrated in FIG. 4.

The method 550 can illustrate one example of unlocking a computing device with a keyless cable lock. As illustrated by method 550, the lock head 504-4 can be rotated when the actuator 508-3 moves the latch head 506-3 from a first location to a second location. As described herein, the method 550 can illustrate how an authentication technique provided to a computing device can result in providing electrical power to an actuator 508-3 to allow the lock head 504 to be rotated and removed through the aperture 502.

The above specification, examples and data provide a description of the methods and applications, and use of the system and method of the present disclosure. Since many examples can be made without departing from the spirit and scope of the system and method of the present disclosure, this specification merely sets forth some of the many possible example configurations and implementations.

What is claimed:

1. A locking mechanism, comprising:
an aperture to receive a lock head when the lock head is in a first position;
a latch head to prevent the lock head from moving through the aperture when the lock head is in a second position; and
an actuator coupled to the latch head to move the lock head from the second position to the first position in response to an authentication.

2. The locking mechanism of claim 1, comprising a controller to provide an electrical power to the actuator in response to the authentication.

3. The locking mechanism of claim 1, wherein the latch head is moved from a first location to a second location by the lock head when the lock head is positioned within the aperture in the first position.

4. The locking mechanism of claim 3, wherein the latch head is moved from the second location to the first location by a resistive element when the lock head is in the second position.

5. The locking mechanism of claim 4, wherein the actuator moves the latch head from the first location to the second location when the actuator is provided electrical power in response to the authentication.

6. The locking mechanism of claim 1, wherein the aperture is shaped to receive the lock head in the first position and prevent insertion and removal of the lock head in the second position.

7. The locking mechanism of claim 1, wherein the latch head covers a portion of the aperture when the latch head is in a first location.

8. A computing device, comprising:
a first enclosure that includes an aperture;
a second enclosure positioned within the first enclosure at a location of the aperture;
an actuator positioned within the second enclosure;
a latch head coupled to the actuator to receive a lock head positioned within the aperture, wherein the lock head moves the latch head from an unlocked state to a locked state when the lock head is positioned within the aperture; and
a controller coupled to the actuator, wherein the controller comprises instructions to:
receive an authentication provided to the computing device; and
provide electrical power to the actuator to move the latch head from the locked state to the unlocked state.

9. The computing device of claim 8, wherein the lock head moves from a first position to a second position to move the latch head from the unlocked state to the locked state.

10. The computing device of claim 9, wherein the latch head prevents the lock head from moving between the first position and the second position when the latch head is in the locked state.

11. The computing device of claim 10, wherein the actuator moves the latch head away from the lock head when the latch head is moved from the locked state to the unlocked state.

12. A system, comprising:
a keyless lock that includes a rotatable cable head coupled to a lock head, wherein the rotatable cable head moves the lock head between a first position and a second position;
a locking mechanism positioned within an enclosure that includes an aperture to receive the lock head of the keyless lock when the lock head is in the first position, wherein the locking mechanism comprises:
a latch head that includes a first portion coupled to a link and a second portion that is coupled to a resistive device, wherein the resistive device moves the latch head into a locked location when the cable head is in the second position within the aperture;
an actuator coupled to the link of the latch head to move the latch head into an unlocked location when the actuator receives electrical power in response to a valid authentication.

13. The system of claim 12, wherein rotatable cable head moves the lock head from the first position to the second position when the lock head is within the aperture to allow the resistive device to move the latch head into the locked location.

14. The system of claim 12, wherein the lock head interacts with first portion and the second portion of the latch head when the lock head is in the first position and the lock head is received by the second portion of the latch head when the lock head is in the second position.

15. The system of claim 12, wherein the latch head prevents the cable head from being moved by the rotatable cable head when the latch head is in the locked location and the latch head allows the cable head to be moved by the rotatable cable head when the latch head is in the unlocked location.
